(19) United States
(12) Patent Application Publication
(10) Pub. No.: US 2023/0121398 A1
(43) Pub. Date: Apr. 20, 2023

(54) BLOCKAGE DETECTION OF HIGH-RESOLUTION LIDAR SENSOR

(71) Applicant: Continental Autonomous Mobility US, LLC, Auburn Hills, MI (US)

(72) Inventors: Niklas Zimmermann, Ulm (DE); Jan Michael Masur, Lindau (DE)

(73) Assignee: Continental Autonomous Mobility US, LLC, Auburn Hills, MI (US)

(21) Appl. No.: 17/904,122

(22) PCT Filed: Feb. 12, 2021
(86) PCT No.: PCT/US2021/070151

§ 371 Date: Aug. 12, 2022

Related U.S. Application Data
(60) Provisional application No. 62/975,736, filed on Feb. 12, 2020.
(60) Provisional application No. 62/976,608, filed on Feb. 14, 2020.

(51) Int. Cl. G01S 7/497

(52) U.S. Cl. CPC G01S 7/497; G01S 2007/4975

(57) ABSTRACT

A lidar sensor assembly includes a plurality of light sources configured to generate light and a plurality of photodetectors for detecting the light potentially reflected off of objects in a field of view. Each of the photodetectors is associated with and configured to receive the light generated by one of the plurality of light sources. A generally transparent cover is disposed between (a) at least one of plurality of light sources and the plurality of photodetectors and (b) the field of view. The assembly further includes a processor in communication with the plurality of light sources and the plurality of photodetectors. The processor is configured to receive signals from the plurality of photodetectors. The processor is further configured to determine whether a blockage of the generally transparent cover exists based at least partially on the signals from the plurality of photodetectors.

### CROSS-REFERENCE TO RELATED APPLICATIONS

The present application is a National Stage Application under 35 U.S.C. § 371 of International Patent Application No.PCT/US2021/070151 filed on Feb. 12, 2021, and claims priority from U.S. provisional patent applications Nos. 62/975,736, filed on Feb. 12, 2020, and 62/976,608, filed on Feb. 14, 2020, each of which is hereby incorporated by reference.

### TECHNICAL FIELD

The technical field relates generally to lidar sensors and more particularly to blockage detection on lidar sensors.

### BACKGROUND

Lidar sensors, like camera, radar and other ADAS sensors suffer from significant performance degradation when the field of view of the sensor is blocked by any foreign material on the window of the sensor through which it views the environment. In the particular case of a lidar sensor, the impact of blockage will be significant as the sensor is mounted outside of the car where it would be directly facing the environment making it susceptible to blockage. These blockage materials and structures on the window include but are not limited to water drops, snow, salt, ice, condensation, splash, spray, dirt, mud, dust, fouling, stickers, shatter, scratches, etc.

The performance of the sensor degrades due to several reasons in case of blockage. First, the power of the laser is partially or fully blocked reducing the maximum detectable distance. The blocking materials may degrade the quality of the image or point cloud by decreasing the resolution, contrast, sharpness and range accuracy. The blocking materials may hinder the view of part of or all of the field of view. Finally, most blocking materials create a “halo” around objects creating false returns around objects causing blurring of the image.

As such, it is desirable to detect the blockage of the sensor at all times to help take appropriate measures in event of blockage, e.g., activate the washer or heater to remove the blockage. If the blockage still persists after cleaning or heating of the window, the sensor may transition into low performance mode and notify the driver to remove blockage or go to service. In addition, other desirable features and characteristics will become apparent from the subsequent summary and detailed description, and the appended claims, taken in conjunction with the accompanying drawings and this background.

### BRIEF SUMMARY

In one exemplary embodiment, a lidar sensor assembly includes a plurality of light sources configured to generate light for illuminating a field of view. The assembly also includes a plurality of photodetectors for detecting the light potentially reflected off of objects in the field of view. Each of the photodetectors is associated with and configured to receive the light generated by one of the plurality of light sources. A generally transparent cover is disposed between (a) at least one of plurality of light sources and the plurality of photodetectors and (b) the field of view. The assembly further includes a processor in communication with the plurality of light sources and the plurality of photodetectors. The processor is configured to receive signals from the plurality of photodetectors. The processor is further configured to determine whether a blockage of the generally transparent cover exists based at least partially on the signals from the plurality of photodetectors.

A method of determining a blockage on a generally transparent cover 108 of a lidar sensor assembly 100 is also provided. The lidar sensor assembly 100 includes a plurality of light sources 102A, 102B, 102C configured to generate light for illuminating a field of view. The assembly 100 also includes a plurality of photodetectors 104A, 104B, 104C for detecting the light potentially reflected off of objects 106 in the field of view. Each of the photodetectors 104A, 104B, 104C is associated with and configured to receive the light generated by one of the plurality of light sources 102A, 102B, 102C. The generally transparent cover 108 is disposed between (a) at least one of plurality of light sources 102A, 102B, 102C and the plurality of photodetectors 104A, 104B, 104C and (b) the field of view. The method includes receiving signals from the plurality of photodetectors 104A, 104B, 104C. The method further includes selectively ceasing operation of at least one of the light sources 102A, 102B, 102C. The method also includes determining whether a blockage 300 of the generally transparent cover 108 exists based at least partially on a signal being generated from a photodetector 104A, 104B, 104C associated with one of the light sources 102A, 102B, 102C having a ceased operation.

### BRIEF DESCRIPTION OF THE DRAWINGS

Other advantages of the disclosed subject matter will be readily appreciated, as the same becomes better understood by reference to the following detailed description when considered in connection with the accompanying drawings wherein:

FIG. 1 is a block diagram showing a lidar sensor assembly according to one exemplary embodiment having a plurality of light sources and a plurality of photodetectors with each light source generating light;

FIG. 2 is a block diagram showing the lidar sensor assembly of FIG. 1 wherein one of the plurality of photodetectors has ceased operation;

FIG. 3 is a block diagram showing the lidar sensor assembly of FIG. 1 wherein one of the plurality of photodetectors has ceased operation and a partial blockage of a generally transparent cover;

FIG. 4 is a block diagram showing a lidar sensor assembly according to another exemplary embodiment having a plurality of light sources and a plurality of photodetectors;

FIG. 5 is a graph showing amplitude of signals generated by the plurality of photodetectors over time;

FIG. 6 is a block diagram showing the lidar sensor assembly of FIG. 4 with a blockage of the generally transparent cover; and

FIG. 7 is a graph showing amplitude of signals generated by the plurality of photodetectors in multiple blockage situations.

### DETAILED DESCRIPTION

Referring to the Figures, wherein like numerals indicate like parts throughout the several views, a lidar sensor assembly 100 is shown and described herein.

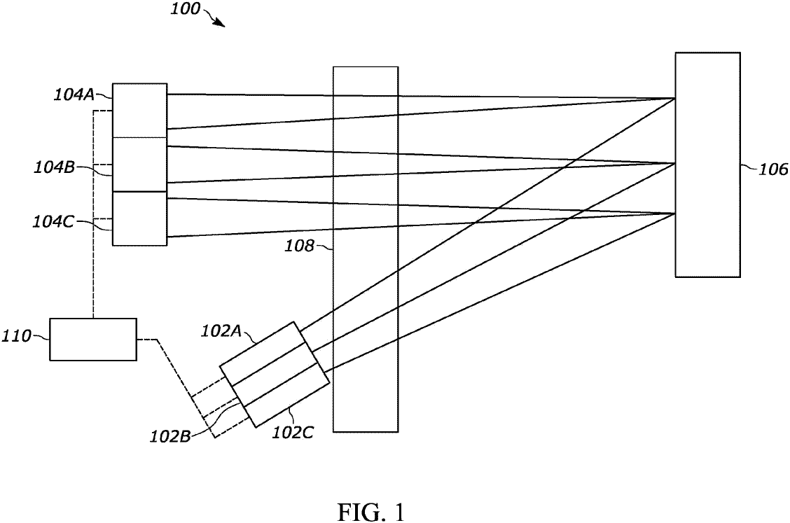

The lidar sensor assembly 100, according to one exemplary embodiment, is shown in FIG. 1. The lidar sensor assembly 100 includes a plurality of light sources 102A, 102B, 102C configured to generate light for illuminating a field of view (not numbered). The light sources 102A, 102B, 102C may be a laser, laser diode, and/or other suitable device for generating light.

In the embodiments shown in the figures, the plurality of light sources 102A, 102B, 102C include a first light source 102A, a second light source 102B, and a third light source 102C. However, it should be appreciated that these embodiments are merely exemplary and that other quantities and configurations of the light sources 102A, 102B, 102C may alternatively be implemented.

The light sources 102A, 102B, 102C of the exemplary embodiments are configured to generate light in one or more specified wavelengths, e.g., in the infrared portion of the electromagnetic spectrum. In some embodiments, the light sources 102A, 102B, 102C are configured to generate pulses of light, while in other embodiments, a continuous application of light may be applied.

The lidar sensor assembly 100 also includes a plurality of photodetectors 104A, 104B, 104C. The photodetectors 104A, 104B, 104C are configured to detect the light potentially reflected off of objects 106 in the field of view. Each of the photodetectors 104A, 104B, 104C is associated with and configured to receive the light generated by one of the plurality of light sources 102A, 102B, 102C.

In the embodiments shown in the figures, the plurality of photodetectors is implemented with a first photodetector 104A, a second photodetector 104B, and a third photodetector 104C. The first photodetector 104A is configured to receive the light generated by the first light source 102A, the second photodetector 104B is configured to receive the light generated by the second light source 102B, and the third photodetector 104C is configured to receive the light generated by the third light source 102C. While these photodetectors 104A, 104B, 104C are configured to receive the light generated by their corresponding light sources 102A, 102B, 102C, it must be appreciated that these photodetectors 104A, 104B, 104C may receive other light emissions, as described in greater detail below.

In the figures, a single object 106 is show disposed in the field of view. It should be appreciated that numerous objects 106, or no objects 106 at all, may be present in the field of view at any moment.

The lidar sensor assembly 100 also includes a generally transparent cover 108. The disposed between (a) at least one of plurality of light sources and the plurality of photodetectors and (b) the field of view; and

It should be appreciated that the figures and illustrations of this disclosure do not show and describe every element necessary for practical application of the assembly 100. For example, the lidar sensor assembly 100 may also include transmission optics (not shown) for delivering the light generated by the light sources 102A, 102B, 102C to the field of view and receiving optics (not shown) for receiving light reflected off an object 106 in the field of view. It should be appreciated that the transmission and/or the receiving optics may be integrated with the cover 108.

The lidar sensor assembly 100 further includes a processor 110. The processor 110 is a device capable of performing calculations and/or performing a series of instructions (i.e., running a program). For example, the processor 110 may be implemented with one or more of a microprocessor, microcontroller, application specific integrated circuit (“ASIC”), field-programmable gate array (“FPGA”), and/or other suitable device.

The processor 110 is in communication with the plurality of light sources 102A, 102B, 102C and the plurality of photodetectors 104A, 104B, 104C. As such, data and/or other signals may be sent and/or received between the various components. In one embodiment, electrical and/or optical communication cables (not numbered) are connected between the processor 110 and the light sources 102A, 102B, 102C and the photodetectors 104A, 104B, 104C. In another embodiment, a vehicle communications bus (not shown) may be implemented. In yet another embodiment, wireless communication techniques may be utilized.

The processor 110 is configured to receive signals from the plurality of photodetectors 104A, 104B, 104C. Those of ordinary skill in the art appreciate that the “signals” may be a stream of data. The signals provided by the photodetectors 104A, 104B, 104C inform the processor 110 as to an amount of light collected by each photodetector 104A, 104B, 104C.

The processor 110 is also configured to determine whether a blockage of the generally transparent cover exists based at least partially on the signals from the plurality of photodetectors 104A, 104B, 104C. As described in further details below, the determination of whether a blockage exists may be achieved by several techniques.

Referring now to FIG. 1, the lidar sensor assembly 100 of this embodiment is operating in a state in which all three light sources 102A, 102B, 102C are producing light. In this case, all three beams of light are projected through the generally transparent cover 108, reflect off of the object back and back through the cover 108, and are sensed by the respective three photodetectors 104A, 104B, 104C, and accordingly, by the processor 110.

In some embodiments, the processor 110 is configured to selectively cease operation of at least one of the light sources 102A, 102B, 102C. That is, the processor 110 may turn off one or more of the light sources 102A, 102B, 102C, such that the respective light sources 102A, 102B, 102C do not emit light.

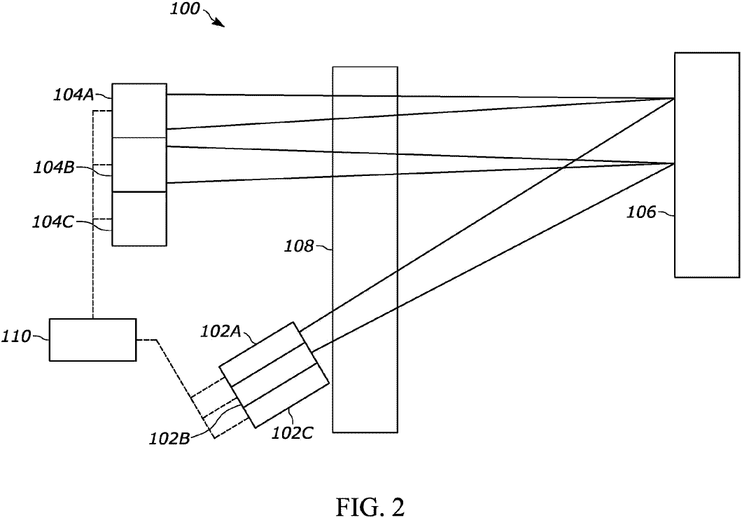

For example, with reference now to FIG. 2, the processor 110 may cease operation of the third light source 102C. In this particular figure, the generally transparent cover 108 is substantially free from blockages. Thus, the first and second photodetectors 104A, 104B sense the light reflected off the object 106, but the third photodetector 104C does not.

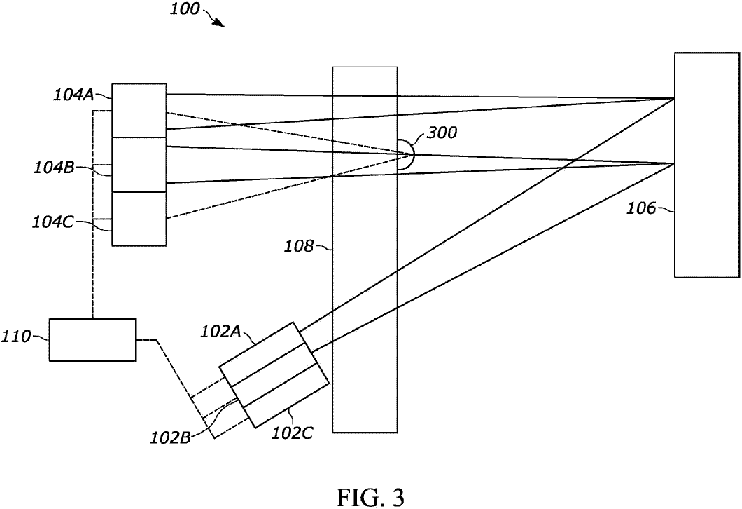

FIG. 3 shows the same configuration as FIG. 2, except that a blockage 300 (e.g., a drop off water) is present on the cover 108. In this configuration, the third light source 102C is not emitting light. However, the blockage 300 acts to scatter and/or diffuse the light from the second light source 102C. This scattering reflects light towards the first and third photodetectors 104A, 104C. The processor 110, sensing the signals from all three photodetectors 104A, 104B, 104C is then able to recognize that the blockage 300 of the generally transparent cover 108 is present. More particularly, the processor 110, which knows that the third light source 102C is not illuminated, may detect that the blockage 300 is present at least partially on the signal generated by the third photodetector 104C.

Said another way, the processor 110 is configured to determine whether a blockage 300 of the generally transparent cover 108 exists based at least partially on a signal from at least one of the plurality of photodetectors 104A, 104B, 104C associated with the plurality of light sources 102A, 102B, 102C which have ceased operation.

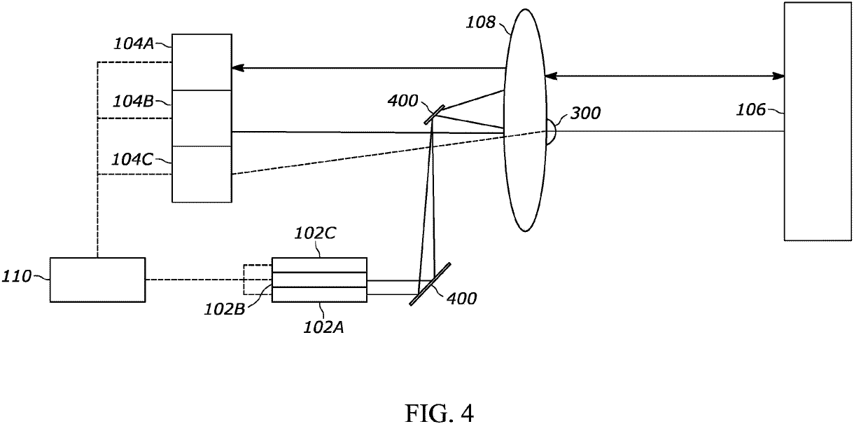

FIG. 4 shows the lidar sensor assembly 100 with a coaxial configuration, where the transmitted light and the received light share the same relative path. In this configuration, at least one mirror 400 is utilized to direct the light generated by the light sources 102A, 102B, 102C through the generally transparent cover 108 into the field of view. Optics (not numbered) may be integrated with the cover 108.

In the embodiment shown in FIG. 4, the third light source 102C is turned off and a blockage 300 of the generally transparent cover 108 exists, similar to the embodiment shown in FIG. 3.

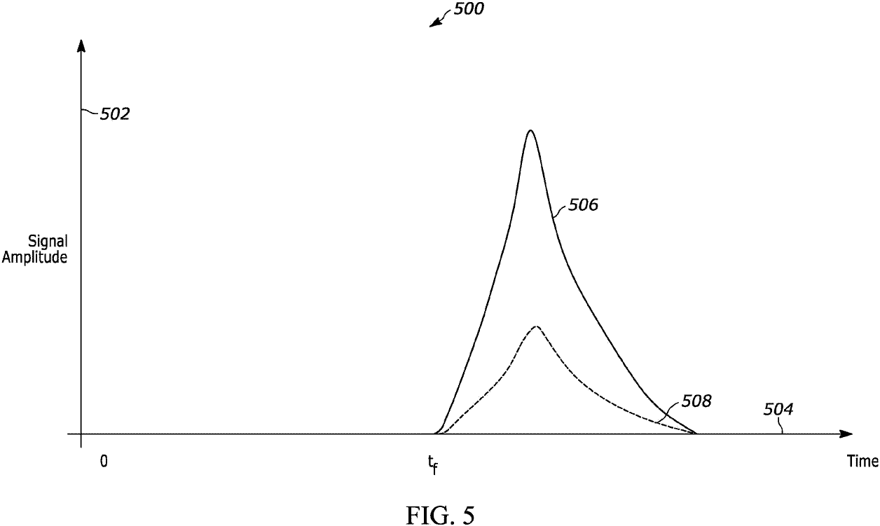

FIG. 5 shows a chart 500 illustrating signal amplitude 502 over time 504 for various photodetectors 104A, 104B, 104C. Curve 506 shows the signal received at the first and second photodetectors 104A, 104B due to light returned from the detected object 106. Curve 508 shows the signal received at the third photodetector 104C due to light scattered by the blockage 300.

In another exemplary embodiment, the processor 110 of the lidar sensor assembly 100 is configured to calculate a time of flight of the light generated by the light sources 102A, 102B, 102C. Accordingly, the processor 110 is in communication with the plurality of light sources 102A, 102B, 102C and configured to record the time the light is generated by at least one of the plurality of light sources 102A, 102B, 102C. The processor 110 is also in communication with the plurality of photodetectors 104A, 104B, 104 and may record when the light is received. With this recorded data, the processor 110 can calculate the time of flight of a light pulse or light pulses.

The processor 110 is further configured to determine whether a blockage 300 of the generally transparent cover 108 exists based at least partially on the calculated time of flight. In one embodiment, this determination may be achieved using solely the time of flight calculation. In another embodiment, this determination may be achieved using the time of flight calculation in concert with the selective ceasing of operation of one or more of the light sources 102A, 102B, 102C, along with the signal from at least one of the plurality of photodetectors 104A, 104B, 104C associated with the plurality of light sources 102A, 102B, 102C which have ceased operation.

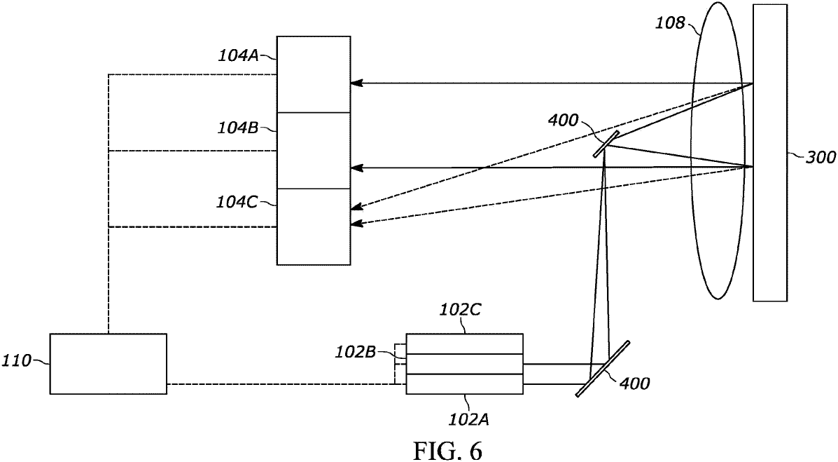

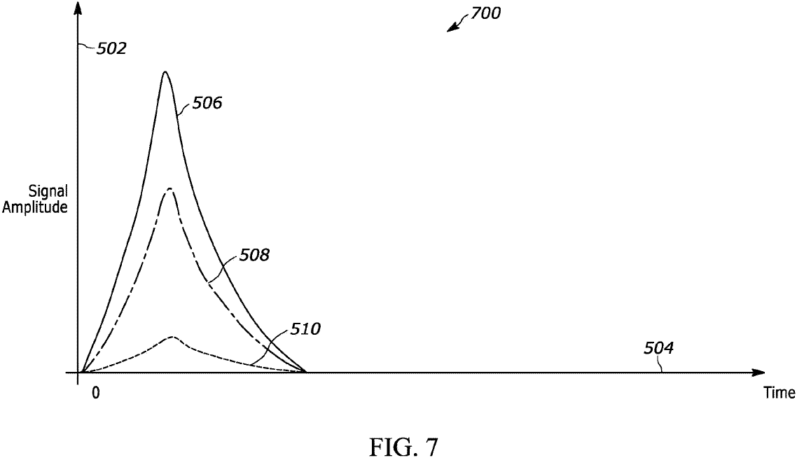

In the situation shown in FIG. 6, the blockage 300 covers most or all of the generally transparent cover 108. The first and second light sources 102A, 102B provide a pulse of light while the third light source 102C is deactivated. FIG. 7 shows a chart 700 showing potential resulting signal amplitudes 502 over time 504. Specifically, curve 506 shows the amplitude of the received signal on the first and second photodetectors 104A, 104B that occurs due to the reflection of the light from the first and second light sources 102A, 102B on the blockage 300. Curve 508 shows the amplitude of the received signal on the third photodetector 104C due to cross-talk from the light from the first and second light sources 102A, 102B reflected on the blockage 300. Curve 510 is provided for reference purposes only and illustrates the expected amplitude of the received signal on the third photodetector 104C due to cross-talk should there be no blockage 300.

The disclosure also provides a method of determining a blockage on a generally transparent cover 108 of a lidar sensor assembly 100. The lidar sensor assembly 100 includes a plurality of light sources 102A, 102B, 102C configured to generate light for illuminating a field of view. The assembly 100 also includes a plurality of photodetectors 104A, 104B, 104C for detecting the light potentially reflected off of objects 106 in the field of view. Each of the photodetectors 104A, 104B, 104C is associated with and configured to receive the light generated by one of the plurality of light sources 102A, 102B, 102C. The generally transparent cover 108 is disposed between (a) at least one of plurality of light sources 102A, 102B, 102C and the plurality of photodetectors 104A, 104B, 104C and (b) the field of view. The method includes receiving signals from the plurality of photodetectors 104A, 104B, 104C. The method further includes selectively ceasing operation of at least one of the light sources 102A, 102B, 102C. The method also includes determining whether a blockage 300 of the generally transparent cover 108 exists based at least partially on a signal being generated from a photodetector 104A, 104B, 104C associated with one of the light sources 102A, 102B, 102C having a ceased operation.

The method may also include calculating a time of flight between when the light is generated by at least one of the plurality of light sources 102A, 102B, 102C and when the light is received by at least one of the plurality of photodetectors 104A, 104B, 104C. The method may also include determining whether a blockage 300 of the generally transparent cover 108 exists based at least partially on the calculated time of flight.

The present invention has been described herein in an illustrative manner, and it is to be understood that the terminology which has been used is intended to be in the nature of words of description rather than of limitation. Obviously, many modifications and variations of the invention are possible in light of the above teachings. The invention may be practiced otherwise than as specifically described within the scope of the appended claims.

What is claimed is:

1. A lidar sensor assembly, comprising:
a plurality of light sources configured to generate light for illuminating a field of view;
a plurality of photodetectors for detecting the light potentially reflected off of objects in the field of view, wherein each of said photodetectors is associated with and configured to receive the light generated by one of said plurality of light sources;
a generally transparent cover disposed between (a) at least one of plurality of light sources and the plurality of photodetectors and (b) the field of view; and
a processor in communication with said plurality of light sources and said plurality of photodetectors and configured to
receive signals from said plurality of photodetectors, and
determine whether a blockage of the generally transparent cover exists based at least partially on the signals from said plurality of photodetectors.

2. The lidar sensor assembly as set forth in claim 1 wherein said processor is also in communication with said plurality of light sources to selectively cease operation of at least one of said light sources.

3. The lidar sensor assembly as set forth in claim 2 wherein said processor is configured to determine whether a blockage of the generally transparent cover exists based at least partially on a signal from at least one of said plurality of photodetectors associated with said plurality of light sources which have ceased operation.

4. The lidar assembly as set forth in claim 2 wherein said plurality of light sources comprises a first light source, a second light source, and a third light source.

5. The lidar assembly as set forth in claim 4 wherein said plurality of photodetectors includes a first photodetector configured to receive the light generated by said first light source, a second photodetector configured to receive the light generated by said second light source, and a third photodetector configured to receive the light generated by said third light source.

6. The lidar assembly as set forth in claim 5 wherein said processor ceases operation of said third light source and determines whether a blockage of the generally transparent cover exists based at least partially on a signal generated by said third photodetector.

7. The lidar assembly as set forth in claim 1 wherein said processor is in communication with said plurality of light sources and configured to calculate a time of flight between when the light is generated by at least one of said plurality of light sources and when the light is received by at least one of said plurality of photodetectors.

8. The lidar assembly as set forth in claim 7 wherein said processor is configured to determine whether a blockage of the generally transparent cover exists based at least partially on the calculated time of flight.

9. The lidar sensor assembly as set forth in claim 7 wherein said processor is also in communication with said plurality of light sources to selectively cease operation of at least one of said light sources.

10. The lidar assembly as set forth in claim 9 wherein said processor is configured to determine whether a blockage of the generally transparent cover exists based at least partially on the calculated time of flight and a signal from at least one of said plurality of photodetectors associated with said plurality of light sources which have ceased operation.

11. A method of determining a blockage on a generally transparent cover of a lidar sensor assembly, the lidar sensor assembly including a plurality of light sources configured to generate light for illuminating a field of view, a plurality of photodetectors for detecting the light potentially reflected off of objects in the field of view, wherein each of the photodetectors is associated with and configured to receive the light generated by one of the plurality of light sources, and the generally transparent cover disposed between (a) at least one of plurality of light sources and the plurality of photodetectors and (b) the field of view, said method comprising:
receiving signals from the plurality of photodetectors; and
selectively ceasing operation of at least one of the light sources; and
determining whether a blockage of the generally transparent cover exists based at least partially on a signal being generated from a photodetector associated with one of the light sources having a ceased operation.

12. The method as set forth in claim 11 further comprising calculating a time of flight between when the light is generated by at least one of said plurality of light sources and when the light is received by at least one of said plurality of photodetectors.

13. The method as set forth in claim 12 wherein determining whether a blockage of the generally transparent cover exists based at least partially on the calculated time of flight.
